(19) United States
(12) Patent Application Publication
(10) Pub. No.: US 2015/0128122 A1
(43) Pub. Date: May 7, 2015

(54) Systems and Methods for Updating Software

(71) Applicant: Tencent Technology (Shenzhen) Company Limited, Shenzhen (CN)

(72) Inventor: Dong Wang, Shenzhen (CN)

(21) Appl. No.: 14/591,313

(22) Filed: Jan. 7, 2015

Related U.S. Application Data
(63) Continuation of application No. PCT/CN2014/078251, filed on May 23, 2014.

(30) Foreign Application Priority Data
Jul. 5, 2013 (CN) 201310282359.8

(51) Int. Cl. G06F 9/445; H04L 29/08

(52) U.S. Cl. CPC G06F 8/65; H04L 67/10
USPC 717/170

(57) ABSTRACT

Systems and methods are provided for software update. For example, first version information of one or more first software applications associated with a user identifier is received from a client; whether the first software applications associated with the user identifier are to be updated is determined according to the first version information of the first software applications; and in response to the first software applications being determined to be updated, an update instruction is sent to the client, wherein the update instruction contains one or more identifiers of the first software applications so that the client can download and update the first software applications.

### CROSS-REFERENCES TO RELATED APPLICATIONS

The application claims priority to Chinese Patent Application No. 201310282359.8, filed Jul. 5, 2013, incorporated by reference herein for all purposes.

### BACKGROUND OF THE INVENTION

Certain embodiments of the present invention are directed to computer technology. More particularly, some embodiments of the invention provide updating systems and methods. Merely by way of example, some embodiments of the invention have been applied to computer software. But it would be recognized that the invention has a much broader range of applicability.

Software is often frequently updated, particularly game software. Newly developed game software or updated game software is often saved on a server. When a user accesses a game scene, the server may push a prompt to a client and then the client indicates that new games are available or a particular game needs to be updated. A user can download new game software or updated game software from the server using the client. Then, the software downloaded to the client is installed for software update, and the game begins.

The above-noted conventional technology has some disadvantages. For example, the new software or the updated software is not downloaded until the user accesses the game scene, which often results in an unnecessarily long update time and negatively affects the efficiency of user communication with software applications.

Hence it is highly desirable to improve the techniques for software update.

### BRIEF SUMMARY OF THE INVENTION

According to one embodiment, a method is provided for software update. For example, first version information of one or more first software applications associated with a user identifier is received from a client; whether the first software applications associated with the user identifier are to be updated is determined according to the first version information of the first software applications; and in response to the first software applications being determined to be updated, an update instruction is sent to the client, wherein the update instruction contains one or more identifiers of the first software applications so that the client can download and update the first software applications.

According to another embodiment, a method is provided for software update. For example, first version information of one or more first software applications associated with a user identifier is sent to a server upon the acquisition of a user login prompt; an update instruction is received from the server, wherein the update instruction contains one or more identifiers of the first software applications; and the first software applications are downloaded and updated according to the identifiers of the first software applications.

According to yet another embodiment, a server includes: a receiving unit configured to receive first version information of one or more first software applications associated with a user identifier from a client; a determining unit configured to determine whether the first software applications associated with the user identifier are to be updated according to the first version information of the first software applications; and a sending unit configured to, in response to the first software applications being determined to be updated, send to the client an update instruction, wherein the update instruction contains one or more identifiers of the first software applications so that the client can download and update the first software applications.

In one embodiment, a client includes: a sending unit configured to send to a server first version information of one or more first software applications associated with a user identifier upon the acquisition of a user login prompt; a receiving unit configured to receive an update instruction from the server, wherein the update instruction contains one or more identifiers of the first software applications; a downloading unit configured to download the first software applications according to the identifiers of the first software applications; and an updating unit configured to update the first software applications.

In another embodiment, a system for software update includes: a server and a client. The server includes: a first receiving unit configured to receive first version information of one or more first software applications associated with a user identifier from the client; a determining unit configured to determine whether the first software applications associated with the user identifier are to be updated according to the first version information of the first software applications; and a sending unit configured to, in response to the first software applications being determined to be updated, send to the client an update instruction, wherein the update instruction contains one or more identifiers of the first software applications so that the client can download and update the first software applications. The client includes: a sending unit configured to send to the server the first version information of the one or more first software applications associated with the user identifier upon the acquisition of a user login prompt; a second receiving unit configured to receive the update instruction from the server, wherein the update instruction contains the one or more identifiers of the first software applications; a downloading unit configured to download the first software applications according to the identifiers of the first software applications; and an updating unit configured to update the first software applications.

In yet another embodiment, a non-transitory computer readable storage medium includes programming instructions for software update. The programming instructions are configured to cause one or more data processors to execute certain operations. For example, first version information of one or more first software applications associated with a user identifier is received from a client; whether the first software applications associated with the user identifier are to be updated is determined according to the first version information of the first software applications; and in response to the first software applications being determined to be updated, an update instruction is sent to the client, wherein the update instruction contains one or more identifiers of the first software applications so that the client can download and update the first software applications.

In yet another embodiment, a non-transitory computer readable storage medium includes programming instructions for software update. The programming instructions are configured to cause one or more data processors to execute certain operations. For example, first version information of one or more first software applications associated with a user identifier is sent to a server upon the acquisition of a user login prompt; an update instruction is received from the server, wherein the update instruction contains one or more identifiers of the first software applications; and the first software applications are downloaded and updated according to the identifiers of the first software applications.

For example, the systems and methods disclosed herein are configured to download and/or update software in advance to improve the efficiency of software update. In another example, the systems and methods disclosed herein are configured so that a client can download and update software applications in advance without requiring user access to software applications (e.g., user access to a game scene), hence increasing efficiency of software update.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a method for software update according to one embodiment of the present invention.

FIG. 2 is a simplified diagram showing a method for software update according to another embodiment of the present invention.

FIG. 3 is a simplified diagram showing a method for software update according to yet another embodiment of the present invention.

FIG. 4 is a simplified diagram showing a server for software update according to one embodiment of the present invention.

FIG. 5 is a simplified diagram showing a determining unit as part of the server as shown in FIG. 4 according to one embodiment of the present invention.

FIG. 6 is a simplified diagram showing a determining unit as part of the server as shown in FIG. 4 according to another embodiment of the present invention.

FIG. 7 is a simplified diagram showing a determining unit as part of the server as shown in FIG. 4 according to yet another embodiment of the present invention.

FIG. 8 is a simplified diagram showing a client according to one embodiment of the present invention.

FIG. 9 is a simplified diagram showing a client according to another embodiment of the present invention.

FIG. 10 is a simplified diagram showing a client according to yet another embodiment of the present invention.

FIG. 11 is a simplified diagram showing a server according to yet another embodiment of the present invention.

FIG. 12 is a simplified diagram showing a client according to another embodiment of the present invention.

FIG. 13 is a simplified diagram showing a system for software update according to one embodiment of the present invention.

### DETAILED DESCRIPTION OF THE INVENTION

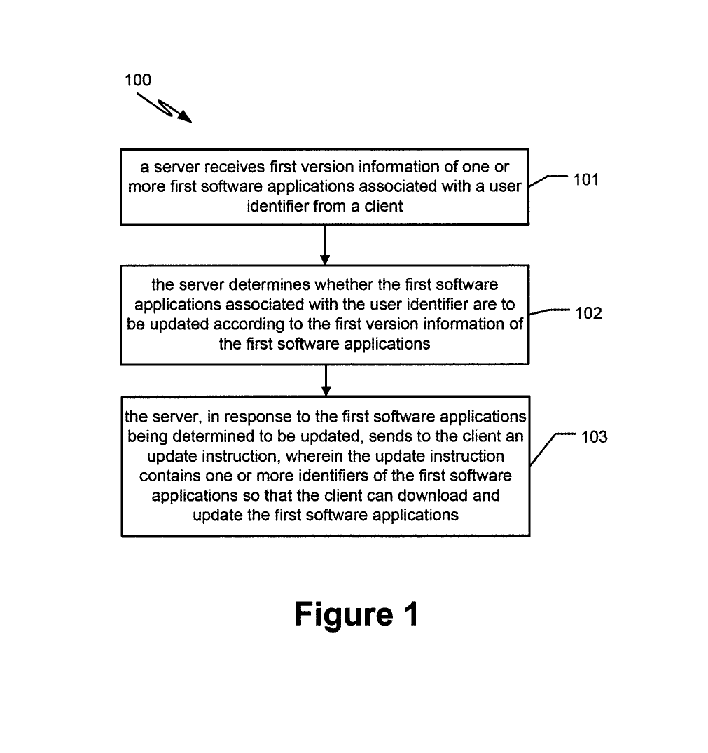

FIG. 1 is a simplified diagram showing a method for software update according to one embodiment of the present invention. The diagram is merely an example, which should not unduly limit the scope of the claims. One of ordinary skill in the art would recognize many variations, alternatives, and modifications. The method 100 includes at least the processes 101-103.

According to one embodiment, during the process 101, a server receives first version information of one or more first software applications associated with a user identifier from a client. For example, the user identifier may be an account of a game player. The account of the game play is unique, and all versions of the game played under the user account are associated with the user account.

According to another embodiment, during the process 102, the server determines whether the first software applications associated with the user identifier are to be updated according to the first version information of the first software applications. For example, during the process 103, the server, in response to the first software applications being determined to be updated, sends to the client an update instruction, wherein the update instruction contains one or more identifiers of the first software applications so that the client can download and update the first software applications.

According to yet another embodiment, the process 102 includes: comparing the first version information of the first software applications with latest version information of the first software applications stored in a server; and in response to the first version information of the first software applications not matching with the latest version information of the first software applications, determining that the first software applications are to be updated.

In one embodiment, the latest version of software is stored on the server. For example, the server can compare the version of the software associated with the user identifier with the corresponding latest version of the software saved on the server. As an example, when it is found that the version of one or a plurality of software applications relating to the user identifier is different from the corresponding latest version of the software applications, it is determined that the software applications are to be updated.

In another embodiment, the process 102 includes: selecting second version information of a second software application from the one or more first software applications, the second software application having a use frequency within a predetermined range; comparing the second version information of the second software application with latest version information of the second software application; and in response to the second version information of the second software application not matching with the latest version information of the second software application, determining the second software application is to be updated.

In yet another embodiment, there may be a plurality of software applications associated with the user identifier but most of them are used with a very low frequency. In order to increase the update efficiency of software, the server may instruct the client to update only the software used with a high frequency. For example, the client reports use records of the game to the server every time the game is played so that the server can store the use records of each software application and hence determine the software whose use frequency is within a predetermined range.

In yet another embodiment, the process 102 includes: selecting second version information of a second software application from the one or more first software applications, the second software application being used by a user within a predetermined period; comparing the second version information of the second software application with latest version information of the second software application; and in response to the second version information of the second software application not matching with the latest version information of the second software application, determining the second software application is to be updated.

According to one embodiment, there are a plurality of software applications associated with the user identifier. For example, most of the software applications are no longer used by the user. There is no need to update these unused software applications. As an example, the server instructs the client to update only the software applications that the user used within the predetermined period. The predetermined period may be last month, last half month or last week, in some embodiments.

According to another embodiment, the process 102 further includes: in response to the first version information of the first software applications not containing information of a newly promoted second software application, determining the second software applications is to be updated. For example, when the server determines that the software application associated with the user identifier does not includes a newly promoted software application (e.g., a newly launched game), the server instructs the client to download the newly promoted software application.

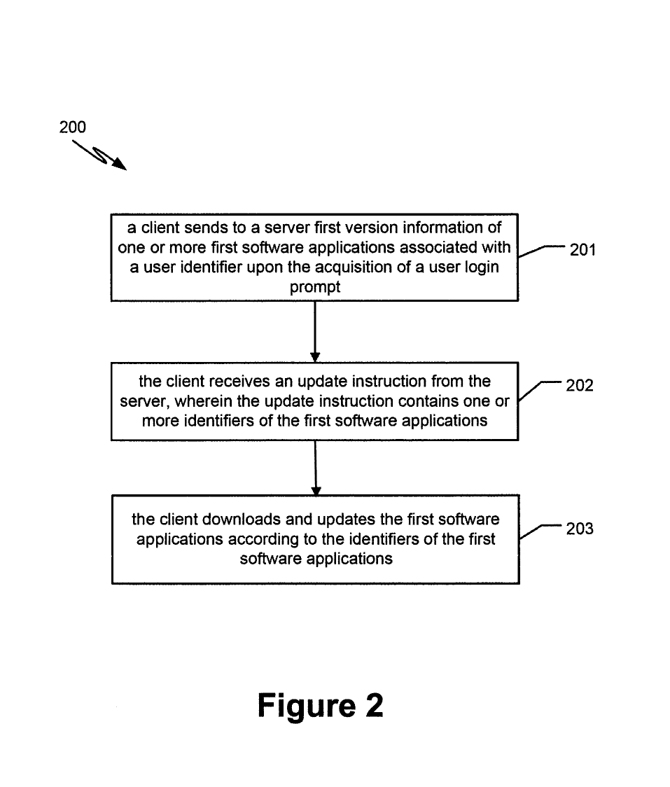

FIG. 2 is a simplified diagram showing a method for software update according to another embodiment of the present invention. The diagram is merely an example, which should not unduly limit the scope of the claims. One of ordinary skill in the art would recognize many variations, alternatives, and modifications. The method 200 includes at least the processes 201-203.

According to one embodiment, during the process 201, a client sends to a server first version information of one or more first software applications associated with a user identifier upon the acquisition of a user login prompt. For example, during the process 202, the client receives an update instruction from the server, wherein the update instruction contains one or more identifiers of the first software applications. As an example, during the process 203, the client downloads and updates the first software applications according to the identifiers of the first software applications.

According to another embodiment, the method 200 further includes: receiving an update prompt from the server, the update prompt indicating the first software applications; detecting whether a second software application of the first software applications has been downloaded; and in response to the second software application being downloaded, updating the second software application. For example, the client may determine if any software application needs updating according to the update prompt sent by the server after acquiring a user login prompt. If the client finds that the software to be updated has been downloaded, the client can directly update the software to be updated.

According to yet another embodiment, the method 200 further includes: in response to the second software application not being downloaded, detecting a task for downloading the second software application; and in response to the task not being detected, triggering the downloading of the second software application. For example, when the client finds that no software to be updated has been downloaded, the client detects if the download tasks include a download task of the software to be updated. In another example, if the client detects the download task of the software to be updated, the client installs a port after the download is completed. In yet another example, if the client does not detect the download task of the software to be updated, the client triggers the downloading of the software to be updated. In yet another example, when downloading the software to be updated, it is determined if the present version of the software is useable. If the present version of the software is useable, the present version of the software can be used this time and the downloaded new version of the software may be updated upon next login. On the other hand, if the present version is not usable, the software is updated before it becomes usable.

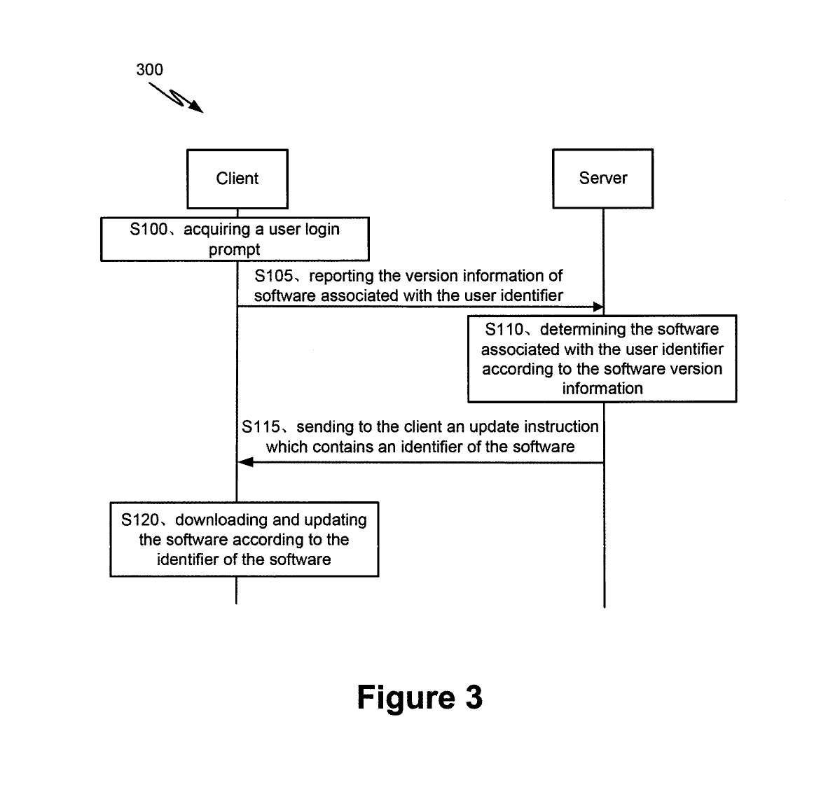

FIG. 3 is a simplified diagram showing a method for software update according to yet another embodiment of the present invention. The diagram is merely an example, which should not unduly limit the scope of the claims. One of ordinary skill in the art would recognize many variations, alternatives, and modifications. The method 300 includes at least the processes S100-S120.

According to one embodiment, during the process S100, the client acquires a user login prompt. For example, during the process S105, the client reports to a server the version information of software associated with the user identifier. As an example, during the process S110, the server determines the software associated with the user identifier according to the software version information.

According to another embodiment, during the process S115, the server sends to the client an update instruction which contains an identifier of the software. For example, during the process S120, the client downloads and updates the software according to the identifier of the software.

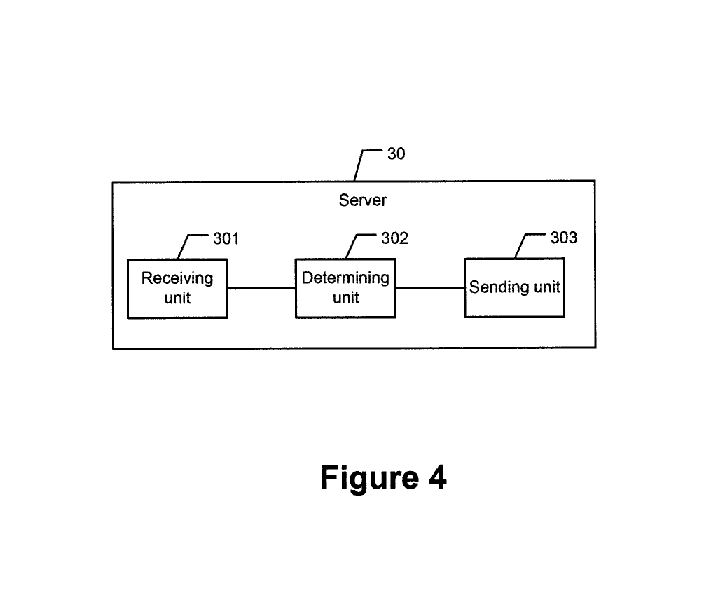

FIG. 4 is a simplified diagram showing a server for software update according to one embodiment of the present invention. The diagram is merely an example, which should not unduly limit the scope of the claims. One of ordinary skill in the art would recognize many variations, alternatives, and modifications.

According to one embodiment, the server 30 includes: a receiving unit 301 configured to receive first version information of one or more first software applications associated with a user identifier from a client, a determining unit 302 configured to determine whether the first software applications associated with the user identifier are to be updated according to the first version information of the first software applications, and a sending unit 303 configured to, in response to the first software applications being determined to be updated, send to the client an update instruction, wherein the update instruction contains one or more identifiers of the first software applications so that the client can download and update the first software applications.

According to another embodiment, the receiving unit 301 receives client-reported version information of a software application associated with a user identifier. For example, the determining unit 302 determines the software associated with the user identifier according to the version information of the software received by the receiving unit 301. In another example, the sending unit 303 sends to the client an update instruction when the software exists, wherein the update instruction contains an identifier of the software so that the client can download and update the software.

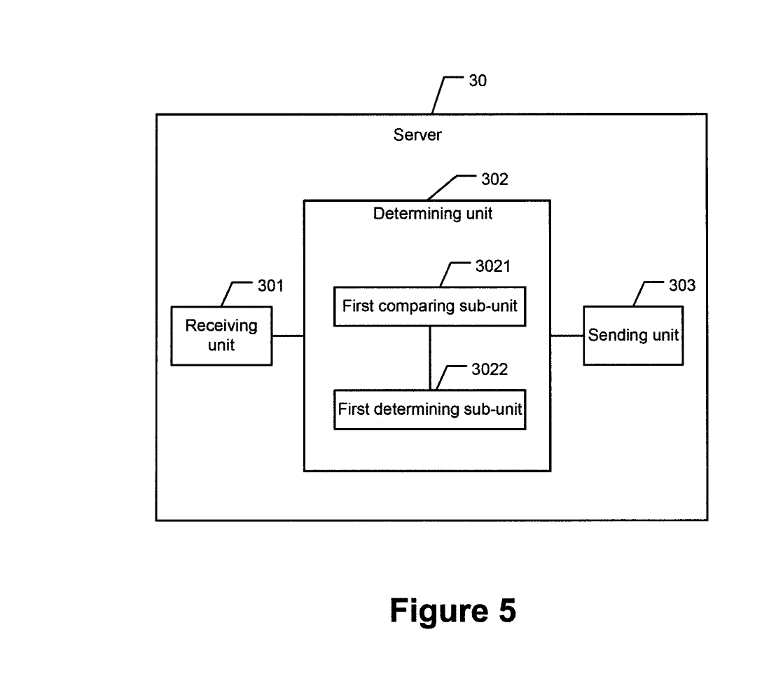

FIG. 5 is a simplified diagram showing a determining unit as part of the server 30 according to one embodiment of the present invention. The diagram is merely an example, which should not unduly limit the scope of the claims. One of ordinary skill in the art would recognize many variations, alternatives, and modifications.

According to one embodiment, the determining unit 302 includes: a first comparing sub-unit 3021 configured to compare the first version information of the first software applications with latest version information of the first software applications stored in the server, and a first determining sub-unit 3022 configured to, in response to the first version information of the first software applications not matching with the latest version information of the first software applications, determine that the first software applications are to be updated.

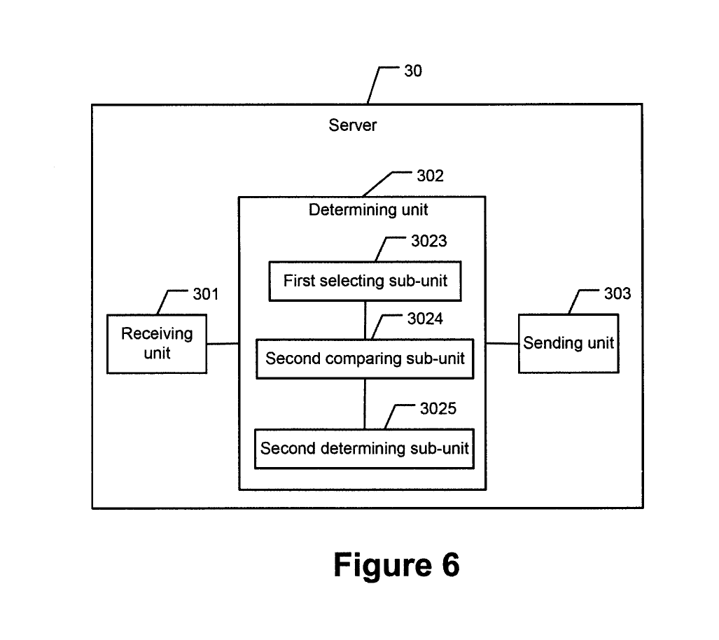

FIG. 6 is a simplified diagram showing a determining unit as part of the server 30 according to another embodiment of the present invention. The diagram is merely an example, which should not unduly limit the scope of the claims. One of ordinary skill in the art would recognize many variations, alternatives, and modifications.

According to one embodiment, the determining unit 302 includes: a first selecting sub-unit 3023 configured to select second version information of a second software application from the one or more first software applications, the second software application having a use frequency within a predetermined range, a second comparing sub-unit 3024 configured to compare the second version information of the second software application with latest version information of the second software application, and a second determining sub-unit 3025 configured to, in response to the second version information of the second software application not matching with the latest version information of the second software application, determine the second software application is to be updated.

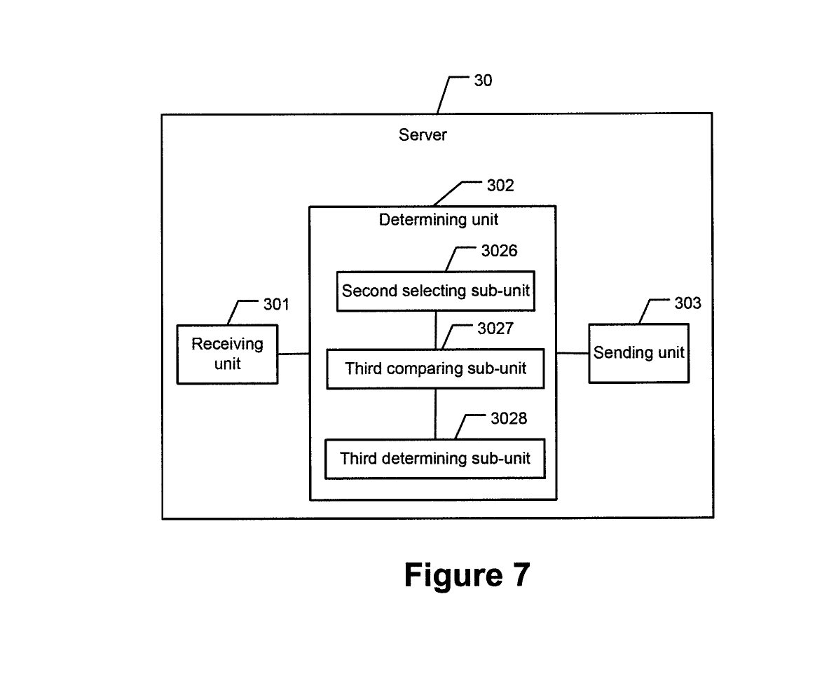

FIG. 7 is a simplified diagram showing a determining unit as part of the server 30 according to yet another embodiment of the present invention. The diagram is merely an example, which should not unduly limit the scope of the claims. One of ordinary skill in the art would recognize many variations, alternatives, and modifications.

According to one embodiment, the determining unit 302 includes: a second selecting sub-unit 3026 configured to select second version information of a second software application from the one or more first software applications, the second software application being used by a user within a predetermined period, a third comparing sub-unit 3027 configured to compare the second version information of the second software application with latest version information of the second software application, and a third determining sub-unit 3028 configured to, in response to the second version information of the second software application not matching with the latest version information of the second software application, determine the second software application is to be updated.

Referring to FIG. 4, FIG. 5, FIG. 6, and/or FIG. 7, the determining unit 302 is configured to, in response to the first version information of the first software applications not containing information of a newly promoted second software application, determine the second software application is to be updated.

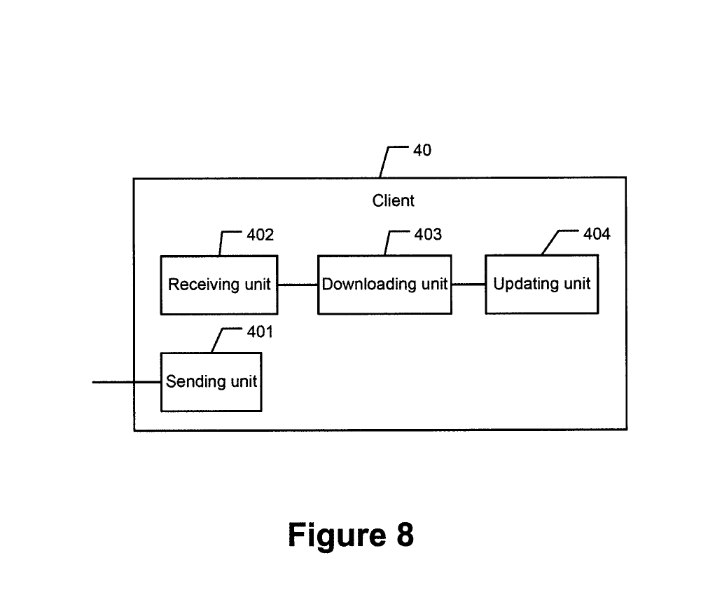

FIG. 8 is a simplified diagram showing a client according to one embodiment of the present invention. The diagram is merely an example, which should not unduly limit the scope of the claims. One of ordinary skill in the art would recognize many variations, alternatives, and modifications.

According to one embodiment, the client 40 includes: a sending unit 401 configured to send to a server first version information of one or more first software applications associated with a user identifier upon the acquisition of a user login prompt, a receiving unit 402 configured to receive an update instruction from the server, wherein the update instruction contains one or more identifiers of the first software applications, a downloading unit 403 configured to download the first software applications according to the identifiers of the first software applications, and an updating unit 404 configured to update the first software applications.

According to another embodiment, the sending unit 401 sends to a server the version information of software associated with the user identifier after acquiring a user login prompt. For example, the receiving unit 402 receives an update instruction from the server, wherein the update instruction contains an identifier of the software. In another example, the downloading unit 403 downloads the corresponding software according to the identifier of the software received by the receiving unit 402. In yet another example, the updating unit 404 updates the software downloaded by the downloading unit 403.

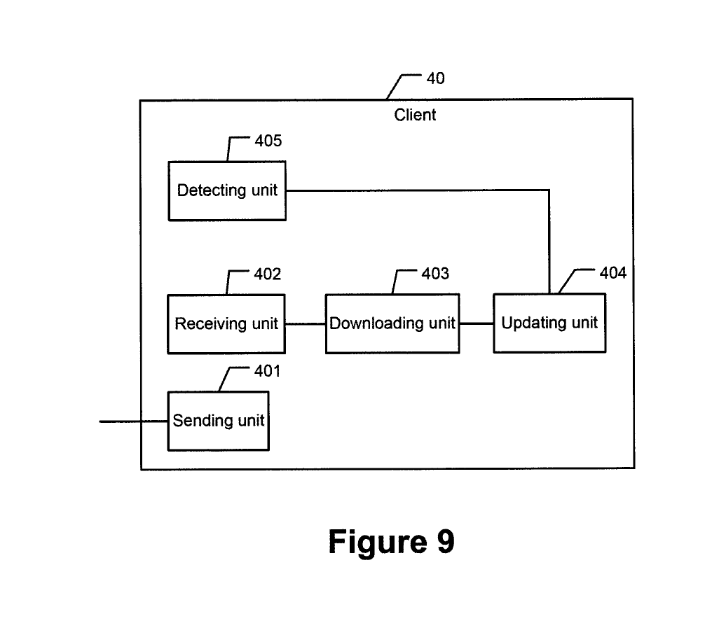

FIG. 9 is a simplified diagram showing a client according to another embodiment of the present invention. The diagram is merely an example, which should not unduly limit the scope of the claims. One of ordinary skill in the art would recognize many variations, alternatives, and modifications. The client 40 further includes a detecting unit 405.

According one embodiment, the receiving unit 402 is configured to receive an update prompt from the server, the update prompt indicating the first software applications. For example, the detecting unit 405 is configured to detect whether a second software application of the first software applications has been downloaded. In another example, the updating unit 404 is configured to, in response to the second software application being downloaded, update the second software application.

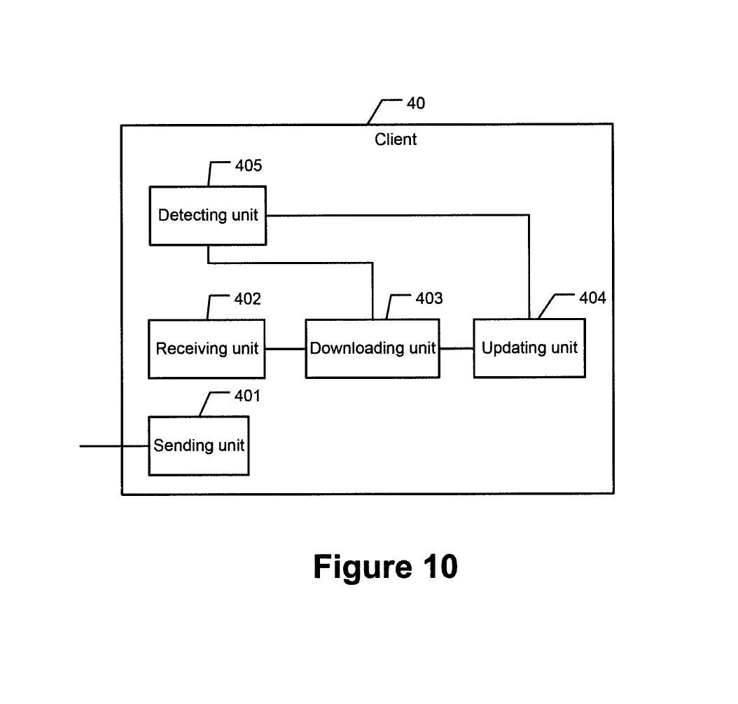

FIG. 10 is a simplified diagram showing a client according to yet another embodiment of the present invention. The diagram is merely an example, which should not unduly limit the scope of the claims. One of ordinary skill in the art would recognize many variations, alternatives, and modifications.

According to one embodiment, the detecting unit 405 is further configured to, in response to the second software application not being downloaded, detect a task for downloading the second software application. For example, the downloading unit 403 is configured to, in response to the task not being detected, trigger the downloading of the second software application.

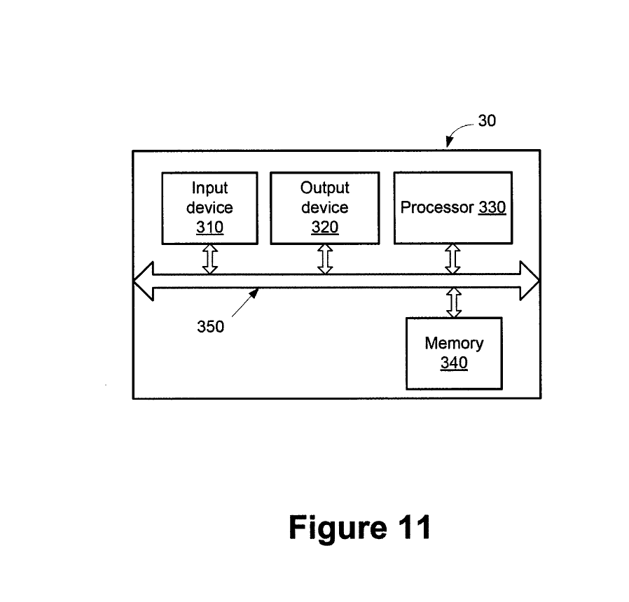

FIG. 11 is a simplified diagram showing a server according to yet another embodiment of the present invention. The diagram is merely an example, which should not unduly limit the scope of the claims. One of ordinary skill in the art would recognize many variations, alternatives, and modifications. The server 30 includes an input device 310, an output device 320, a processor 330 and a memory 340.

According to one embodiment, the memory 340 may include a read-only memory and a random access memory and is configured to provide instructions and data to the processor 330. For example, part of the memory 340 may also include a non-volatile random access memory (NVRAM). In another example, the memory 340 stores the following elements and may execute module or data structure or their subsets or supersets: operating instructions including various types of operating instructions for realization of various operations; and an operating system including various system programs for realization of various basic services and handling of hardware-based tasks.

According to another embodiment, the processor 330 executes the following operations through calling the operating instructions stored in the memory 340 (or stored in the operating system): through the input device 310, receiving client-reported version information of a software application associated with a user identifier; determining the software associated with the user identifier according to the software version information; and sending to the client an update instruction when the software exists, wherein the update instruction contains an identifier of the software so that the client can download and update the software.

According to yet another embodiment, the processor 330 controls the operations of the server 30. For example, the processor 330 may include a CPU (central processing unit). In another example, the memory 340 may include a read-only memory and a random access memory and is configured to provide instructions and data to the processor 330. Part of the memory 340 may also include a non-volatile random access memory (NVRAM). In practice, various modules of the server 30 are coupled together via a bus system 350. Other than the data bus, the bus system 350 may further include a mains bus, a control bus and/or a state signal bus, in some embodiments.

In certain embodiments, the method 100, the method 200 and/or the method 300 can be applied to the processor 330 or realized by the processor 330. For example, the processor 330 may include an IC chip capable of signal processing. Various operations of the method 100, the method 200 and/or the method 300 may be completed through the integrated logic circuit of hardware or instruction of software in the processor 330, according to some embodiments. As an example, the processor 330 may include a general-purpose processor, a digital signal processor (DSP), an application-specific integrated circuit (ASIC), a field-programmable gate array (FPGA) or any other programmable logic devices, discrete gates or transistor logic devices or discrete hardware components. The general-purpose processor may include microprocessors or any other conventional processors. Various operations of the method 100, the method 200 and/or the method 300 may be directly executed by the decoding processor hardware or executed by hardware and software modules in the decoding processor, according to certain embodiments. For example, the software modules may be located in a random access memory, a flash memory, a read-only memory, a programmable read-only memory or a rewritable programmable memory, a register or any other storage media, which are located in the memory 340. As an example, the processor 330 reads the information from the memory 340 and completes various operations of the method 100, the method 200 and/or the method 300 via certain hardware.

According to one embodiment, the processor 330 is configured to compare the first version information of the first software applications with latest version information of the first software applications stored in a server, and in response to the first version information of the first software applications not matching with the latest version information of the first software applications, determine that the first software applications are to be updated. For example, the processor 330 is configured to select second version information of a second software application from the one or more first software applications, the second software application having a use frequency within a predetermined range, compare the second version information of the second software application with latest version information of the second software application, and in response to the second version information of the second software application not matching with the latest version information of the second software application, determine the second software application is to be updated.

According to another embodiment, the processor 330 is further configured to select second version information of a second software application from the one or more first software applications, the second software application being used by a user within a predetermined period, compare the second version information of the second software application with latest version information of the second software application, and in response to the second version information of the second software application not matching with the latest version information of the second software application, determine the second software application is to be updated. In yet another example, the processor 330 is further configured to, in response to the first version information of the first software applications not containing information of a newly promoted second software application, determining the second software applications is to be updated.

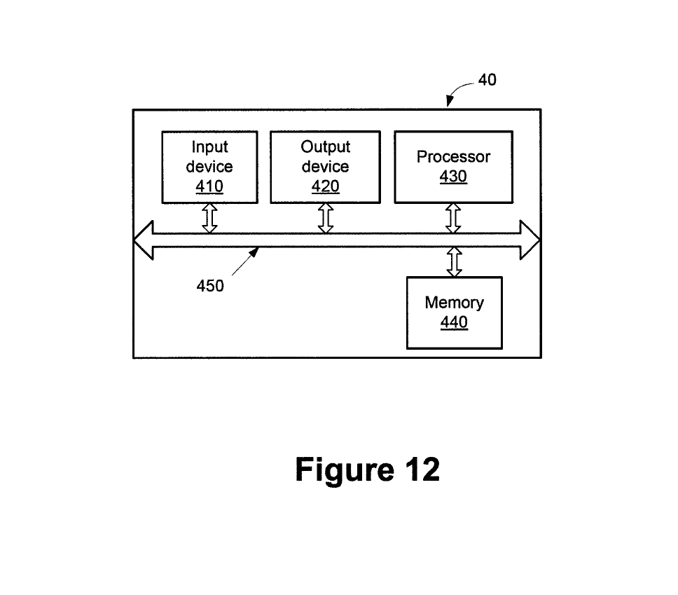

FIG. 12 is a simplified diagram showing a client according to another embodiment of the present invention. The diagram is merely an example, which should not unduly limit the scope of the claims. One of ordinary skill in the art would recognize many variations, alternatives, and modifications. The client 40 includes an input device 410, an output device 420, a processor 430 and a memory 440.

According to one embodiment, the memory 440 may include a read-only memory and a random access memory and is configured to provide instructions and data to the processor 430. For example, part of the memory 440 may also include a non-volatile random access memory (NVRAM). In another example, the memory 440 stores the following elements and may execute module or data structure or their subsets or supersets: operating instructions including various types of operating instructions for realization of various operations; and an operating system including various system programs for realization of various basic services and handling of hardware-based tasks.

According to another embodiment, the processor 430 executes the following operations through calling the operating instructions stored in the memory 440 (or stored in the operating system): through the input device 410, receiving client-reported version information of a software application associated with a user identifier; determining the software associated with the user identifier according to the software version information; and sending to the client an update instruction when the software exists, wherein the update instruction contains an identifier of the software so that the client can download and update the software.

According to yet another embodiment, the processor 430 controls the operations of the server 30. For example, the processor 430 may include a CPU (central processing unit). In another example, the memory 440 may include a read-only memory and a random access memory and is configured to provide instructions and data to the processor 430. Part of the memory 440 may also include a non-volatile random access memory (NVRAM). In practice, various modules of the server 30 are coupled together via a bus system 350. Other than the data bus, the bus system 350 may further include a mains bus, a control bus and/or a state signal bus, in some embodiments.

In certain embodiments, the method 100, the method 200 and/or the method 300 can be applied to the processor 330 or realized by the processor 330. For example, the processor 330 may include an IC chip capable of signal processing. Various operations of the method 100, the method 200 and/or the method 300 may be completed through the integrated logic circuit of hardware or instruction of software in the processor 330, according to some embodiments. As an example, the processor 330 may include a general-purpose processor, a digital signal processor (DSP), an application-specific integrated circuit (ASIC), a field-programmable gate array (FPGA) or any other programmable logic devices, discrete gates or transistor logic devices or discrete hardware components. The general-purpose processor may include microprocessors or any other conventional processors. Various operations of the method 100, the method 200 and/or the method 300 may be directly executed by the decoding processor hardware or executed by hardware and software modules in the decoding processor, according to certain embodiments. For example, the software modules may be located in a random access memory, a flash memory, a read-only memory, a programmable read-only memory or a rewritable programmable memory, a register or any other storage media, which are located in the memory 440. As an example, the processor 430 reads the information from the memory 440 and completes various operations of the method 100, the method 200 and/or the method 300 via certain hardware.

According to one embodiment, the input device 410 receives an update prompt from the server, the update prompt indicating the first software applications. For example, the processor 430 is configured to detect whether a second software application of the first software applications has been downloaded; and in response to the second software application being downloaded, update the second software application. In another example, the processor 430 is further configured to, in response to the second software application not being downloaded, detect a task for downloading the second software application, and in response to the task not being detected, trigger the downloading of the second software application.

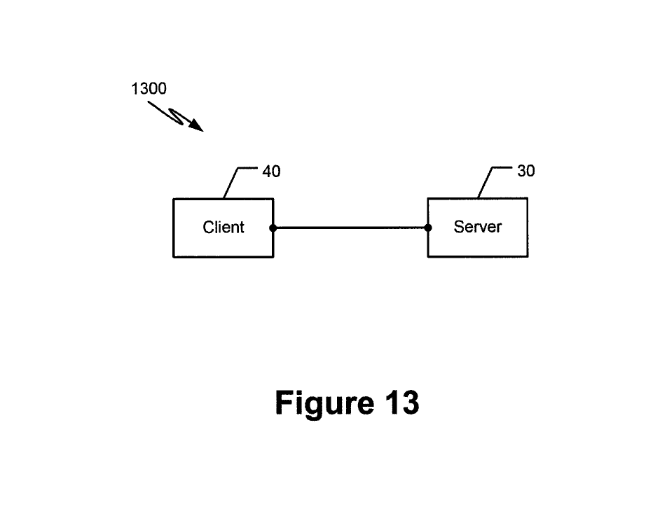

FIG. 13 is a simplified diagram showing a system for software update according to one embodiment of the present invention. The diagram is merely an example, which should not unduly limit the scope of the claims. One of ordinary skill in the art would recognize many variations, alternatives, and modifications. The system 1300 includes a server 30 and a client 40.

According to one embodiment, the server 30 is configured to receive first version information of one or more first software applications associated with a user identifier from a client, determine whether the first software applications associated with the user identifier are to be updated according to the first version information of the first software applications, and in response to the first software applications being determined to be updated, send to the client an update instruction, wherein the update instruction contains one or more identifiers of the first software applications so that the client can download and update the first software applications. According to another embodiment, the client 40 is configured to send to a server first version information of one or more first software applications associated with a user identifier upon the acquisition of a user login prompt, receive an update instruction from the server, wherein the update instruction contains one or more identifiers of the first software applications, and download and update the first software applications according to the identifiers of the first software applications.

According to another embodiment, a method is provided for software update. For example, first version information of one or more first software applications associated with a user identifier is received from a client; whether the first software applications associated with the user identifier are to be updated is determined according to the first version information of the first software applications; and in response to the first software applications being determined to be updated, an update instruction is sent to the client, wherein the update instruction contains one or more identifiers of the first software applications so that the client can download and update the first software applications. For example, the method is implemented according to at least FIG. 1 and/or FIG. 3.

According to another embodiment, a method is provided for software update. For example, first version information of one or more first software applications associated with a user identifier is sent to a server upon the acquisition of a user login prompt; an update instruction is received from the server, wherein the update instruction contains one or more identifiers of the first software applications; and the first software applications are downloaded and updated according to the identifiers of the first software applications. For example, the method is implemented according to at least FIG. 2.

According to yet another embodiment, a server includes: a receiving unit configured to receive first version information of one or more first software applications associated with a user identifier from a client; a determining unit configured to determine whether the first software applications associated with the user identifier are to be updated according to the first version information of the first software applications; and a sending unit configured to, in response to the first software applications being determined to be updated, send to the client an update instruction, wherein the update instruction contains one or more identifiers of the first software applications so that the client can download and update the first software applications. For example, the server is implemented according to at least FIG. 4, FIG. 5, FIG. 6, FIG. 7, and/or FIG. 11.

In one embodiment, a client includes: a sending unit configured to send to a server first version information of one or more first software applications associated with a user identifier upon the acquisition of a user login prompt; a receiving unit configured to receive an update instruction from the server, wherein the update instruction contains one or more identifiers of the first software applications; a downloading unit configured to download the first software applications according to the identifiers of the first software applications; and an updating unit configured to update the first software applications. For example, the client is implemented according to at least FIG. 8, FIG. 9, FIG. 10, and/or FIG. 12.

In another embodiment, a system for software update includes: a server and a client. The server includes: a first receiving unit configured to receive first version information of one or more first software applications associated with a user identifier from the client; a determining unit configured to determine whether the first software applications associated with the user identifier are to be updated according to the first version information of the first software applications; and a sending unit configured to, in response to the first software applications being determined to be updated, send to the client an update instruction, wherein the update instruction contains one or more identifiers of the first software applications so that the client can download and update the first software applications. The client includes: a sending unit configured to send to the server the first version information of the one or more first software applications associated with the user identifier upon the acquisition of a user login prompt; a second receiving unit configured to receive the update instruction from the server, wherein the update instruction contains the one or more identifiers of the first software applications; a downloading unit configured to download the first software applications according to the identifiers of the first software applications; and an updating unit configured to update the first software applications. For example, the system is implemented according to at least FIG. 13.

In yet another embodiment, a non-transitory computer readable storage medium includes programming instructions for software update. The programming instructions are configured to cause one or more data processors to execute certain operations. For example, first version information of one or more first software applications associated with a user identifier is received from a client; whether the first software applications associated with the user identifier are to be updated is determined according to the first version information of the first software applications; and in response to the first software applications being determined to be updated, an update instruction is sent to the client, wherein the update instruction contains one or more identifiers of the first software applications so that the client can download and update the first software applications. For example, the storage medium is implemented according to at least FIG. 1 and/or FIG. 3.

In yet another embodiment, a non-transitory computer readable storage medium includes programming instructions for software update. The programming instructions are configured to cause one or more data processors to execute certain operations. For example, first version information of one or more first software applications associated with a user identifier is sent to a server upon the acquisition of a user login prompt; an update instruction is received from the server, wherein the update instruction contains one or more identifiers of the first software applications; and the first software applications are downloaded and updated according to the identifiers of the first software applications. For example, the storage medium is implemented according to at least FIG. 2.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A method for software update, the method comprising:
receiving first version information of one or more first software applications associated with a user identifier from a client;
determining whether the first software applications associated with the user identifier are to be updated according to the first version information of the first software applications; and
in response to the first software applications being determined to be updated, sending to the client an update instruction, wherein the update instruction contains one or more identifiers of the first software applications so that the client can download and update the first software applications.

2. The method of claim 1, wherein the determining whether the first software applications associated with the user identifier are to be updated according to the first version information of the first software applications includes:
comparing the first version information of the first software applications with latest version information of the first software applications stored in a server; and
in response to the first version information of the first software applications not matching with the latest version information of the first software applications, determining that the first software applications are to be updated.

3. The method of claim 1, wherein the determining whether the first software applications associated with the user identifier are to be updated according to the first version information of the first software applications includes:
selecting second version information of a second software application from the one or more first software applications, the second software application having a use frequency within a predetermined range;
comparing the second version information of the second software application with latest version information of the second software application; and
in response to the second version information of the second software application not matching with the latest version information of the second software application, determining the second software application is to be updated.

4. The method of claim 1, wherein the determining whether the first software applications associated with the user identifier are to be updated according to the first version information of the first software applications includes:
selecting second version information of a second software application from the one or more first software applications, the second software application being used by a user within a predetermined period;
comparing the second version information of the second software application with latest version information of the second software application; and
in response to the second version information of the second software application not matching with the latest version information of the second software application, determining the second software application is to be updated.

5. The method of claim 1, wherein the determining whether the first software applications associated with the user identifier are to be updated according to the first version information of the first software applications includes:
in response to the first version information of the first software applications not containing information of a newly promoted second software application, determining the second software applications is to be updated.

6. A method for software update, the method comprising:
sending to a server first version information of one or more first software applications associated with a user identifier upon the acquisition of a user login prompt;
receiving an update instruction from the server, wherein the update instruction contains one or more identifiers of the first software applications; and
downloading and updating the first software applications according to the identifiers of the first software applications.

7. The method of claim 6, further comprising:
receiving an update prompt from the server, the update prompt indicating the first software applications;
detecting whether a second software application of the first software applications has been downloaded; and
in response to the second software application being downloaded, updating the second software application.

8. The method of claim 7, further comprising:
in response to the second software application not being downloaded, detecting a task for downloading the second software application; and
in response to the task not being detected, triggering the downloading of the second software application.

9. A server comprising:
a receiving unit configured to receive first version information of one or more first software applications associated with a user identifier from a client;
a determining unit configured to determine whether the first software applications associated with the user identifier are to be updated according to the first version information of the first software applications; and
a sending unit configured to, in response to the first software applications being determined to be updated, send to the client an update instruction, wherein the update instruction contains one or more identifiers of the first software applications so that the client can download and update the first software applications.

10. The server of claim 9, wherein the determining unit includes:
a first comparing sub-unit configured to compare the first version information of the first software applications with latest version information of the first software applications stored in the server; and
a first determining sub-unit configured to, in response to the first version information of the first software applications not matching with the latest version information of the first software applications, determine that the first software applications are to be updated.

11. The server of claim 9, wherein the determining unit includes:
a first selecting sub-unit configured to select second version information of a second software application from the one or more first software applications, the second software application having a use frequency within a predetermined range;
a second comparing sub-unit configured to compare the second version information of the second software application with latest version information of the second software application; and
a second determining sub-unit configured to, in response to the second version information of the second software application not matching with the latest version information of the second software application, determine the second software application is to be updated.

12. The server of claim 9, wherein the determining unit includes:
a second selecting sub-unit configured to select second version information of a second software application from the one or more first software applications, the second software application being used by a user within a predetermined period;
a third comparing sub-unit configured to compare the second version information of the second software application with latest version information of the second software application; and
a third determining sub-unit configured to, in response to the second version information of the second software application not matching with the latest version information of the second software application, determine the second software application is to be updated.

13. The server of claim 9, wherein the determining unit is configured to, in response to the first version information of the first software applications not containing information of a newly promoted second software application, determine the second software application is to be updated.

14. The server of claim 9, further comprising:
one or more data processors; and
a computer-readable storage medium;
wherein the receiving unit, the determining unit and the sending unit are stored in the storage medium and configured to be executed by the one or more data processors.

15. A client comprising:
a sending unit configured to send to a server first version information of one or more first software applications associated with a user identifier upon the acquisition of a user login prompt;
a receiving unit configured to receive an update instruction from the server, wherein the update instruction contains one or more identifiers of the first software applications;
a downloading unit configured to download the first software applications according to the identifiers of the first software applications; and
an updating unit configured to update the first software applications.

16. The client of claim 15, wherein:
the receiving unit configured to receive an update prompt from the server, the update prompt indicating the first software applications;
the client further includes: a detecting unit configured to detect whether a second software application of the first software applications has been downloaded; and
the updating unit configured to, in response to the second software application being downloaded, update the second software application.

17. The client of claim 16, wherein:
the detecting unit is further configured to, in response to the second software application not being downloaded, detect a task for downloading the second software application; and
the downloading unit is configured to, in response to the task not being detected, trigger the downloading of the second software application.

18. The client of claim 15, further comprising:
one or more data processors; and
a computer-readable storage medium;
wherein the sending unit, the receiving unit, the downloading unit and the updating unit are stored in the storage medium and configured to be executed by the one or more data processors.

19. A system for software update, comprising:
a server; and
a client;
wherein:
the server includes:
a first receiving unit configured to receive first version information of one or more first software applications associated with a user identifier from the client;
a determining unit configured to determine whether the first software applications associated with the user identifier are to be updated according to the first version information of the first software applications; and
a sending unit configured to, in response to the first software applications being determined to be updated, send to the client an update instruction, wherein the update instruction contains one or more identifiers of the first software applications so that the client can download and update the first software applications; and
the client includes:
a sending unit configured to send to the server the first version information of the one or more first software applications associated with the user identifier upon the acquisition of a user login prompt;
a second receiving unit configured to receive the update instruction from the server, wherein the update instruction contains the one or more identifiers of the first software applications;
a downloading unit configured to download the first software applications according to the identifiers of the first software applications; and
an updating unit configured to update the first software applications.

20. A non-transitory computer readable storage medium comprising programming instructions for software update, the programming instructions configured to cause one or more data processors to execute operations comprising:
receiving first version information of one or more first software applications associated with a user identifier from a client;
determining whether the first software applications associated with the user identifier are to be updated according to the first version information of the first software applications; and
in response to the first software applications being determined to be updated, sending to the client an update instruction, wherein the update instruction contains one or more identifiers of the first software applications so that the client can download and update the first software applications.

21. A non-transitory computer readable storage medium comprising programming instructions for software update, the programming instructions configured to cause one or more data processors to execute operations comprising:
sending to a server first version information of one or more first software applications associated with a user identifier upon the acquisition of a user login prompt;
receiving an update instruction from the server, wherein the update instruction contains one or more identifiers of the first software applications; and
downloading and updating the first software applications according to the identifiers of the first software applications.
